(19) United States
(12) Patent Application Publication
(10) Pub. No.: US 2020/0324278 A1
(43) Pub. Date: Oct. 15, 2020

(54) METHOD FOR PREPARING POROUS ORGANIC FRAMEWORK-SUPPORTED ATOMIC NOBLE METAL CATALYSTFOR CATALYTIC OXIDATION OF VOCS AT ROOM TEMPERATURE

(71) Applicant: Tianjin University, Tianjin (CN)

(72) Inventors: Hui DING, Tianjin (CN); Haotian ZHAO, Tianjin (CN); Wei SHANG, Tianjin (CN); Dan ZHAO, Tianjin (CN)

(21) Appl. No.: 16/739,059

(22) Filed: Jan. 9, 2020

Related U.S. Application Data
(63) Continuation of application No. PCT/CN2019/112570, filed on Oct. 22, 2019.

(30) Foreign Application Priority Data
Apr. 12, 2019 (CN) 201910294705.1

(51) Int. Cl. B01J 31/02; B01J 23/52; B01J 23/42; B01J 31/26; B01J 31/28; B01J 37/04; B01J 37/02; B01J 37/34; B01J 37/16; B01J 37/08; B01D 53/86

(52) U.S. Cl. CPC B01J 31/0247; B01D 2258/06; B01J 23/42; B01J 31/26; B01J 31/28; B01J 37/04; B01J 37/0201; B01J 37/343; B01J 37/16; B01J 37/0236; B01J 37/08; B01D 53/8687; B01D 2255/1021; B01D 2255/70; B01J 23/52

(57) ABSTRACT

A method for preparing a porous organic framework-supported atomic noble metal catalyst for catalytic oxidation of VOCs at room temperature, including: (1) adding 2,6-diaminopyridine and 1,3,5-benzenetricarboxylic acid chloride to a triethylamine-containing dichloromethane solution and stirring the reaction mixture; reacting the reaction mixture in an oil bath under heating to produce a porous pyridine-amide framework; (2) impregnating the porous pyridine-amide framework completely in a noble metal salt solution followed by ultrasonication and standing; reducing the porous organic framework-supported noble metal ions with sodium borohydride solution; washing and drying to produce a semi-finished porous pyridine-amide framework-supported atomic noble metal catalyst; (3) calcining the semi-finished catalyst in a muffle furnace to obtain a finished catalyst. The catalyst provided herein has high atomic dispersion and atomic active sites, significantly improving the catalytic efficiency.

### CROSS-REFERENCE TO RELATED APPLICATIONS

This application is a continuation of International Application No. PCT/CN2019/112570, filed on Oct. 22, 2019, which claims the benefit of priority from Chinese Patent Application No. 201910294705.1, filed on Apr. 12, 2019. The content of the aforementioned application, including any intervening amendments thereto, is incorporated herein by reference in its entirety.

### TECHNICAL FIELD

This application relates to a method for preparing a porous organic framework atomic catalyst, and more particularly to a method for preparing a porous organic framework-supported atomic noble metal catalyst for catalytic oxidation of VOCs at room temperature.

### BACKGROUND OF THE INVENTION

Volatile organic compounds (VOCs) are a class of predominant air pollutants. As defined by the World Health Organization, VOCs are those organic compounds having a boiling point of 50-260° C. and a saturated vapor pressure of more than 133 Pa at room temperature, which includes alkanes, alkenes, aromatic hydrocarbons and derivatives thereof, alcohols, aldehydes and ketones, amines and amides, acids and anhydrides.

In China, the conventional methods for treating VOCs include catalytic incineration, low-temperature plasma processing and ultraviolet photocatalysis. However, these methods often require high temperature, which will result in high energy consumption and potential safety problems in the treatment of flammable and explosive VOCs.

### SUMMARY OF THE INVENTION

An object of the invention is to provide a method for preparing a porous organic framework-supported atomic noble metal catalyst for catalytic oxidation of VOCs at room temperature to overcome the shortcomings in the prior art, where the prepared catalyst for catalytic oxidation of VOCs at room temperature has atomic active sites, excellent catalytic activity and reusability.

The technical solutions of the invention are specifically described as follows.

The invention provides a method for preparing a porous pyridine-amide framework-supported atomic noble metal catalyst, comprising:

step (1) adding triethylamine to a dichloromethane solution and stirring evenly to obtain a first solution;

wherein a volume ratio of the triethylamine to the dichloromethane solution is 1:10;

step (2) adding 2,6-diaminopyridine and 1,3,5-benzenetricarboxylic acid chloride to the first solution and stirring evenly to obtain a second solution;

wherein a molar ratio of 2,6-diaminopyridine to 1,3,5-benzenetricarboxylic acid chloride is 3:1; and a volume ratio of 2,6-diaminopyridine and 1,3,5-benzenetricarboxylic acid chloride to the first solution is 1:2;

step (3) reacting the second solution in an oil bath at 30-90° C. for 2-8 h to produce a porous pyridine-amide framework;

step (4) impregnating the porous pyridine-amide framework completely in a 0.05-0.5 mol/L noble metal salt solution; treating the reaction system by ultrasonication for 1-5 h; allowing the reaction system to stand at 10-30° C. for 6-12 h to obtain a porous pyridine-amide framework-supported noble metal;

wherein a noble metal in the noble metal salt solution is 0.05-0.5% by weight of the porous pyridine-amide framework;

step (5) dropwise adding a 0.1-0.5 mol/L sodium borohydride solution to the reaction system containing the porous pyridine-amide framework-supported noble metal; and stirring vigorously until no hydrogen generation is observed to reduce the porous pyridine-amide framework-supported noble metal;

step (6) collecting the reduced porous pyridine-amide framework-supported noble metal from the noble metal salt solution; washing the reduced porous pyridine-amide framework-supported noble metal several times with deionized water; and drying the reduced porous pyridine-amide framework-supported noble metal in a vacuum dryer at 40-80° C. for 2-6 h;

step (7) collecting and calcining the dried porous pyridine-amide framework-supported noble metal obtained in step (6) in a muffle furnace at 100-600° C. for 2-6 h to produce the porous pyridine-amide framework-supported atomic noble metal catalyst.

Compared to the prior art, the invention has the following beneficial effects.

(1) The porous pyridine-amide framework has the characteristics of simple synthesis process, high stability and readily-adjustable active sites. Moreover, the amino group is beneficial to the dispersion of atoms, and the porous structure can avoid atomic agglomeration to a certain extent, which enables the catalyst to truly have atomic active sites, providing higher catalytic activity.

(2) Due to the excellent catalytic activity, the catalyst provided herein is capable of catalytic oxidation of VOCs at room temperature, which reduces the actual energy consumption and enhances the operational safety.

(3) The catalyst has strong stability, desirable reusability and long service life, greatly reducing the cost in industrial applications.

### DETAILED DESCRIPTION OF EMBODIMENTS

The invention will be described in detail below with reference to the embodiments to make the technical solutions fully understood. Obviously, described below are merely preferred embodiments of the invention, which are not intended to limit the invention. It should be noted that various modifications, changes and replacements made by those skilled in the art without paying any creative efforts should fall within the scope of the invention.

The invention provides a method for preparing a porous organic framework-supported atomic noble metal catalyst for catalytic oxidation of VOCs at room temperature, which is specifically described as follows.

(1) Preparation of a Porous Organic Framework

(1-1) Triethylamine is added to a dichloromethane solution, where a volume ratio of the triethylamine to the dichloromethane solution is 1:10. The reaction mixture is evenly stirred to produce a first solution.

(1-2) 2,6-diaminopyridine and 1,3,5-benzenetricarboxylic acid chloride are added into the first solution, where a molar ratio of 2,6-diaminopyridine to 1,3,5-benzenetricarboxylic acid chloride is 3:1, and a volume ratio of 2,6-diaminopyridine and 1,3,5-benzenetricarboxylic acid chloride in total to the first solution is 1:2. The reaction mixture is stirred evenly to produce a second solution.

(1-3) The second solution is reacted in an oil bath at 30-90° C. for 2-8 h to produce a porous pyridine-amide framework.

Preferably, a temperature of the oil bath is 40-60° C. and a reaction time is 4-6 h, where this reaction temperature not only accelerates the reaction, but also avoids damages caused by high temperature to the organic framework.

(2) Preparation of a Porous Organic Framework-Supported Noble Metal by Impregnation

(2-1) The porous organic frame work is impregnated completely in a 0.05-0.5 mol/L noble metal salt solution, treated under ultrasonication for 1-5 h and then placed at 10-30° C. for 6-12 h to produce a porous organic framework-supported noble metal, where the noble metal in the noble metal salt solution is 0.05-0.5% by weight of the porous organic framework.

The noble metal salt solution is preferably a solution of HAuCl₄ or H₂PtCl₆, and more preferably the solution of H₂PtCl₆, because atomic Pt catalyst has better catalytic activity.

Preferably, an ultrasonication time is 1.5-3 h, which allows the noble metal to be evenly loaded on the porous pyridine-amide framework, because a too short ultrasonication time will lead to uneven dispersion, and a too long ultrasonication time will render the process time-consuming.

(2-2) The reaction system containing the porous organic framework-supported noble metal is dropwise added with a 0.1-0.5 mol/L sodium borohydride solution, and stirred vigorously until no hydrogen generation is observed to reduce the porous organic framework-supported noble metal.

(2-3) The reduced porous organic framework-supported noble metal is collected, washed several times with deionized water and dried in a vacuum dryer at 40-80° C. for 2-6 h.

(3) Calcination

The dried porous organic framework-supported noble metal is collected and calcined in a muffle furnace at 100-600° C. for 2-6 h to produce the porous organic framework-supported atomic noble metal catalyst.

Preferably, a calcination temperature is 200-400° C., which avoids the damages caused by high temperature to the porous pyridine-amide framework. Preferably, a calcination time is 3-6 h, which allows the noble metal to be more stably loaded on the porous organic framework.

### Example 1

(1) Preparation of a Porous Organic Framework

(1-1) Triethylamine was added to a dichloromethane solution in a volume ratio of 1:10. Then the reaction mixture was stirred evenly to produce a first solution.

(1-2) 2,6-diaminopyridine and 1,3,5-benzenetricarboxylic acid chloride were added to the first solution, where a molar ratio of 2,6-diaminopyridine to 1,3,5-benzenetricarboxylic acid chloride was 3:1, and a volume ratio of 2,6-diaminopyridine and 1,3,5-benzenetricarboxylic acid chloride to the first solution was 1:2. Then the reaction mixture was stirred evenly to produce a second solution.

(1-3) The second solution was reacted in an oil bath at 30° C. for 8 h to produce a porous pyridine-amide framework.

(2) Loading of Metal Pt by Impregnation

(2-1) The porous pyridine-amide framework was impregnated completely in a 0.05 mol/LH₂PtCl₆ solution, treated by ultrasonication for 1 h and placed at 10° C. for 6 h to produce a porous organic framework-supported Pt⁴⁺, where Pt element in the H₂PtCl₆ solution was 0.05% by weight of the porous pyridine-amide framework.

(2-2) The reaction system containing the porous pyridine-amide framework-supported Pt⁴⁺ was dropwise added with a 0.1 mol/L sodium borohydride solution, and stirred vigorously until no hydrogen generation was observed to reduce the porous pyridine-amide framework-supported Pt⁴⁺ to a porous pyridine-amide framework-supported Pt.

(2-3) The porous pyridine-amide framework-supported Pt was collected, washed several times with deionized water and dried in a vacuum dryer at 40° C. for 6 h.

(3) Calcination

The dried porous pyridine-amide framework-supported Pt was collected and calcined in a muffle furnace at 100° C. for 6 h to produce a porous pyridine-amide framework-supported Pt catalyst with atomic active sites.

The catalyst prepared herein was placed in a fixed bed reactor to catalytically degrade the pollutants including methanol, ethanol, toluene, benzene, ethyl acetate and acetone for the evaluation of catalytic activity. Specifically, the catalyst was placed in a quartz tube with an inner diameter of 8 mm; the reactor had a length of 40 mm; the VOCs had a concentration of 1000 ppm; and a space velocity was 25,000 h⁻¹; and the reaction was performed at 25° C. in the presence of oxygen. The results were shown in Table 1.

### Example 2

(1) Preparation of a Porous Organic Framework

(1-1) Triethylamine was added to a dichloromethane solution in a volume ratio of 1:10. Then the reaction mixture was stirred evenly to produce a first solution.

(1-2) 2,6-diaminopyridine and 1,3,5-benzenetricarboxylic acid chloride were added to the first solution, where a molar ratio of 2,6-diaminopyridine to 1,3,5-benzenetricarboxylic acid chloride was 3:1, and a volume ratio of 2,6-diaminopyridine and 1,3,5-benzenetricarboxylic acid chloride to the first solution was 1:2. Then the reaction mixture was stirred evenly to produce a second solution.

(1-3) The second solution was reacted in an oil bath at 40° C. for 6 h to produce a porous pyridine-amide framework.

(2) Loading of Metal Pt by Impregnation

(2-1) The porous pyridine-amide framework was impregnated completely in a 0.2 mol/LH₂PtCl₆ solution, treated by ultrasonication for 1.5 h and placed at 20° C. for 8 h to produce a porous organic framework-supported Pt⁴⁺, where Pt element in the H₂PtCl₆ solution was 0.1% by weight of the porous pyridine-amide framework.

(2-2) The reaction system containing the porous pyridine-amide framework-supported Pt⁴⁺ was dropwise added with a 0.2 mol/L sodium borohydride solution, and stirred vigorously until no hydrogen generation was observed to reduce the porous pyridine-amide framework-supported Pt⁴⁺ to a porous pyridine-amide framework-supported Pt.

(2-3) The porous pyridine-amide framework-supported Pt was collected, washed several times with deionized water and dried in a vacuum dryer at 50° C. for 4 h.

(3) Calcination

The dried porous pyridine-amide framework-supported Pt was collected and calcined in a muffle furnace at 200° C. for 5 h to produce a porous pyridine-amide framework-supported Pt catalyst with atomic active sites.

The catalyst prepared herein was placed in a fixed bed reactor to catalytically degrade the pollutants including methanol, ethanol, toluene, benzene, ethyl acetate and acetone for the evaluation of catalytic activity. Specifically, the catalyst was placed in a quartz tube with an inner diameter of 8 mm; the reactor had a length of 40 mm; the VOCs had a concentration of 1000 ppm; and a space velocity was 25,000 h⁻¹; and the reaction was performed at 25° C. in the presence of ozone. The results were shown in Table 1.

### Example 3

(1) Preparation of a Porous Organic Framework

(1-1) Triethylamine was added to a dichloromethane solution in a volume ratio of 1:10. Then the reaction mixture was stirred evenly to produce a first solution.

(1-2) 2,6-diaminopyridine and 1,3,5-benzenetricarboxylic acid chloride were added to the first solution, where a molar ratio of 2,6-diaminopyridine to 1,3,5-benzenetricarboxylic acid chloride was 3:1, and a volume ratio of 2,6-diaminopyridine and 1,3,5-benzenetricarboxylic acid chloride to the first solution was 1:2. Then the reaction mixture was stirred evenly to produce a second solution.

(1-3) The second solution was reacted in an oil bath at 50° C. for 5 h to produce a porous pyridine-amide framework.

(2) Loading of Metal Pt by Impregnation

(2-1) The porous pyridine-amide framework was impregnated completely in a 0.3 mol/LH₂PtCl₆ solution, treated by ultrasonication for 2 h and placed at 20° C. for 8 h to produce a porous organic framework-supported Pt⁴⁺, where Pt element in the H₂PtCl₆ solution was 0.2% by weight of the porous pyridine-amide framework.

(2-2) The reaction system containing the porous pyridine-amide framework-supported Pt⁴⁺ was dropwise added with a 0.2 mol/L sodium borohydride solution, and stirred vigorously until no hydrogen generation was observed to reduce the porous pyridine-amide framework-supported Pt⁴⁺ to a porous pyridine-amide framework-supported Pt.

(2-3) The porous pyridine-amide framework-supported Pt was collected, washed several times with deionized water and dried in a vacuum dryer at 60° C. for 3 h.

(3) Calcination

The dried porous pyridine-amide framework-supported Pt was collected and calcined in a muffle furnace at 300° C. for 4 h to produce a porous pyridine-amide framework-supported Pt catalyst with atomic active sites.

The catalyst prepared herein was placed in a fixed bed reactor to catalytically degrade the pollutants including methanol, ethanol, toluene, benzene, ethyl acetate and acetone for the evaluation of catalytic activity. Specifically, the catalyst was placed in a quartz tube with an inner diameter of 8 mm; the reactor had a length of 40 mm; the VOCs had a concentration of 1000 ppm; and a space velocity was 25,000 h⁻¹; and the reaction was performed at 25° C. in the presence of oxygen. The results were shown in Table 1.

### Example 4

(1) Preparation of a Porous Organic Framework

(1-1) Triethylamine was added to a dichloromethane solution in a volume ratio of 1:10. Then the reaction mixture was stirred evenly to produce a first solution.

(1-2) 2,6-diaminopyridine and 1,3,5-benzenetricarboxylic acid chloride were added to the first solution, where a molar ratio of 2,6-diaminopyridine to 1,3,5-benzenetricarboxylic acid chloride was 3:1, and a volume ratio of 2,6-diaminopyridine and 1,3,5-benzenetricarboxylic acid chloride to the first solution was 1:2. Then the reaction mixture was stirred evenly to produce a second solution.

(1-3) The second solution was reacted in an oil bath at 60° C. for 4 h to produce a porous pyridine-amide framework.

(2) Loading of Metal Au by Impregnation

(2-1) The porous pyridine-amide framework was impregnated completely in a 0.4 mol/LHAuCl₄ solution, treated by ultrasonication for 3 h and placed at 20° C. for 8 h to produce a porous organic framework-supported Au³⁺, where Au element in the HAuCl₄ solution was 0.4% by weight of the porous pyridine-amide framework.

(2-2) The reaction system containing the porous pyridine-amide framework-supported Au³⁺ was dropwise added with a 0.2 mol/L sodium borohydride solution, and stirred vigorously until no hydrogen generation was observed to reduce the porous pyridine-amide framework-supported Au³⁺ to a porous pyridine-amide framework-supported Au.

(2-3) The porous pyridine-amide framework-supported Au was collected, washed several times with deionized water and dried in a vacuum dryer at 70° C. for 2.5 h.

(3) Calcination

The dried porous pyridine-amide framework-supported Au was collected and calcined in a muffle furnace at 400° C. for 3 h to produce a porous pyridine-amide framework-supported Au catalyst with atomic active sites.

The catalyst prepared herein was placed in a fixed bed reactor to catalytically degrade the pollutants including methanol, ethanol, toluene, benzene, ethyl acetate and acetone for the evaluation of catalytic activity. Specifically, the catalyst was placed in a quartz tube with an inner diameter of 8 mm; the reactor had a length of 40 mm; the VOCs had a concentration of 1000 ppm; and a space velocity was 25,000 h⁻¹; and the reaction was performed at 25° C. in the presence of oxygen. The results were shown in Table 1.

### Example 5

(1) Preparation of a Porous Organic Framework

(1-1) Triethylamine was added to a dichloromethane solution in a volume ratio of 1:10. Then the reaction mixture was stirred evenly to produce a first solution.

(1-2) 2,6-diaminopyridine and 1,3,5-benzenetricarboxylic acid chloride were added to the first solution, where a molar ratio of 2,6-diaminopyridine to 1,3,5-benzenetricarboxylic acid chloride was 3:1, and a volume ratio of 2,6-diaminopyridine and 1,3,5-benzenetricarboxylic acid chloride to the first solution was 1:2. Then the reaction mixture was stirred evenly to produce a second solution.

(1-3) The second solution was reacted in an oil bath at 90° C. for 2 h to produce a porous pyridine-amide framework.

(2) Loading of Metal Au by Impregnation

(2-1) The porous pyridine-amide framework was impregnated completely in a 0.5 mol/LHAuCl₄ solution, treated by ultrasonication for 5 h and placed at 30° C. for 12 h to produce a porous organic framework-supported Au³⁺, where Au element in the HAuCl₄ solution was 0.5% by weight of the porous pyridine-amide framework.

(2-2) The reaction system containing the porous pyridine-amide framework-supported Au³⁺ was dropwise added with a 0.5 mol/L sodium borohydride solution, and stirred vigorously until no hydrogen generation was observed to reduce the porous pyridine-amide framework-supported Au³⁺ to a porous pyridine-amide framework-supported Au.

(2-3) The porous pyridine-amide framework-supported Au was collected, washed several times with deionized water and dried in a vacuum dryer at 80° C. for 2 h.

(3) Calcination

The dried porous pyridine-amide framework-supported Au was collected and calcined in a muffle furnace at 600° C. for 2 h to produce a porous pyridine-amide framework-supported Au catalyst with atomic active sites.

The catalyst prepared herein was placed in a fixed bed reactor to catalytically degrade the pollutants including methanol, ethanol, toluene, benzene, ethyl acetate and acetone for the evaluation of catalytic activity. Specifically, the catalyst was placed in a quartz tube with an inner diameter of 8 mm; the reactor had a length of 40 mm; the VOCs had a concentration of 1000 ppm; and a space velocity was 25,000 h⁻¹; and the reaction was performed at 25° C. in the presence of ozone. The results were shown in Table 1.

TABLE 1
Evaluation for the normal-temperature catalytic oxidation

| | VOCs | | | | | |
|---|---|---|---|---|---|---|
| | Degradation Rate | | | | | |
| | | | | | | Ethyl |
| Catalyst | Methanol | Ethanol | Toluene | Benzene | Acetone | acetate |
| Example 1 | 91% | 88% | 83% | 81% | 75% | 77% |
| Example 2 | 98% | 93% | 91% | 90% | 85% | 87% |
| Example 3 | 97% | 91% | 90% | 88% | 84% | 86% |
| Example 4 | 93% | 87% | 86% | 84% | 79% | 82% |
| Example 5 | 90% | 85% | 84% | 81% | 77% | 79% |

It can be concluded from Table 1 that the porous pyridine-amide framework-supported atomic Pt or Au metal catalyst showed a desired degradation rate for methanol, ethanol, toluene, benzene, ethyl acetate and acetone, which demonstrated that the catalyst provided herein was suitable for the catalytic degradation of various VOCs.

What is claimed is:

1. A method for preparing a porous organic framework-supported atomic noble metal catalyst for catalytic oxidation of VOCs at room temperature, comprising:
(1) adding triethylamine to a dichloromethane solution; and stirring evenly to produce a first solution;
wherein a volume ratio of triethylamine to dichloromethane is 1:10;
(2) adding 2,6-diaminopyridine and 1,3,5-benzenetricarboxylic acid chloride to the first solution; and stirring evenly to obtain a second solution;
wherein a molar ratio of 2,6-diaminopyridine to 1,3,5-benzenetricarboxylic acid chloride is 3:1; and a volume ratio of 2,6-diaminopyridine and 1,3,5-benzenetricarboxylic acid chloride to the first solution is 1:2;
(3) reacting the second solution in an oil bath at 30-90° C. for 2-8 h to produce a porous pyridine-amide framework;
(4) impregnating the porous pyridine-amide frame work completely in a 0.05-0.5 mol/L noble metal salt solution; treating the reaction system by ultrasonication for 1-5 h; allowing the reaction system to stand at 10-30° C. for 6-12 h to produce a porous organic framework-supported noble metal;
wherein a noble metal in the noble metal salt solution is 0.05-0.5% by weight of the porous organic framework;
(5) dropwise adding a 0.1-0.5 mol/L sodium borohydride solution to the reaction system containing the porous organic framework-supported noble metal; and stirring vigorously until no hydrogen generation is observed to reduce the porous organic framework-supported noble metal;
(6) collecting the reduced porous organic framework-supported noble metal; washing several times with deionized water; drying in a vacuum dryer at 40-80° C. for 2-6 h;
(7) collecting and calcining the dried porous organic framework-supported noble metal obtained in step (6) in a muffle furnace at 100-600° C. for 2-6 h to produce the porous organic framework-supported atomic noble metal catalyst.

2. The method of claim 1, wherein in step (3), a temperature of the oil bath is 40-60° C. and a reaction time is 4-6 h.

3. The method of claim 1, wherein the noble metal salt solution is a HAuCl₄ or H₂PtCl₆ solution.

4. The method of claim 2, wherein the noble metal salt solution is a HAuCl₄ or H₂PtCl₆ solution.

5. The method of claim 3, wherein in step (4), an ultrasonication time is 1.5-3 h.

6. The method of claim 4, wherein in step (4), an ultrasonication time is 1.5-3 h.

7. The method of claim 3, wherein in step (7), a calcination temperature is 200-400° C. and a calcination time is 3-6 h.

8. The method of claim 4, wherein in step (7), a calcination temperature is 200-400° C. and a calcination time is 3-6 h.
